(19) United States
(12) Patent Application Publication
(10) Pub. No.: US 2010/0131739 A1
(43) Pub. Date: May 27, 2010

(54) INTEGRATED CIRCUIT HAVING DATA PROCESSING STAGES AND ELECTRONIC DEVICE INCLUDING THE INTEGRATED CIRCUIT

(75) Inventor: Andre Lepine, Le Mesnil Rouxelin (FR)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 12/594,294

(22) PCT Filed: Apr. 3, 2008
(86) PCT No.: PCT/IB08/51246

§ 371 Date: Oct. 1, 2009

(30) Foreign Application Priority Data
Apr. 4, 2007 (EP) 07105675.8

(51) Int. Cl. G06F 15/76; G06F 9/02

(52) U.S. Cl. 712/29; 712/E09.002

(57) ABSTRACT

An integrated circuit (100) is disclosed that comprises a plurality of data processing stages (110) and a data communication network comprising a plurality of data communication paths between the data processing stages (110). Each data processing stage (110) comprises a hardware layer (160) for processing data received through a data communication path and a software layer (120) arranged to communicate with the software layers of selected other data processing stages for controlling the synchronization of the data communication between the data processing stage (110) and the selected other data processing stages in response to dynamically assigned communication relationships between data processing stage (110) and the respective selected other data processing stages. This allows for the dynamic assignment of data communication synchronization relationships between the various data processing stages (110), which has the advantage that such relationships do not have to be implemented at the design stage of the IC.

The present invention relates to an integrated circuit (IC) comprising a plurality of data processing stages and a data communication network comprising a plurality of data communication paths between the data processing stages, each data processing stage comprising a hardware layer for processing data received through a data communication path.

The present invention further relates to a data processing stage for use in such an integrated circuit.

The present invention yet further relates to an electronic device comprising such an integrated circuit.

Some ICs, e.g., systems on chip (SoCs), provide enhanced data processing, e.g. video and image processing, using a collection of data processing stages, which may be implemented in the form of IP cores. Typically, each data processing stage implements a specific task, e.g. data acquisition, data processing, data mixing, data encoding or decoding, image rendering and so on. The data processing stages may be a part of an IC having a heterogeneous architecture for which the data communication relations between the various data processing stages are unclear at the design stages of the IC. This can lead to the problem that the IC in incapable of handling some data processing scenarios (use cases) because the required data communication dependencies such as data communication synchronization behaviour cannot be established.

US patent application US2005/0019020 discloses a video and audio reproducing apparatus in which the audio and video streams can be resynchronized using a re-synchronizing controlling portion situated between the audio and video receiving portions and audio and video decoding portions. The re-synchronizing controlling portion evaluates characteristics of the incoming audio and/or video stream and adjusts the delay between the incoming streams and the output streams to the decoding portions based on the evaluation results. However, the synchronization types of the data communication between the various portions in the data streams is fixed, which limits the number of different data processing scenarios that can be handled this apparatus.

Amongst others, the present invention seeks to provide an IC that facilitates more versatile configurable synchronization behaviour between its data processing stages.

The present invention further seeks to provide a data processing stage for use with such an IC.

The present invention yet further seeks to provide an electronic device comprising such an IC.

According to an aspect of the present invention, there is provided an IC according to the opening paragraph, wherein each data processing stage further comprises a software layer arranged to communicate with the software layers of selected other data processing stages for controlling the synchronization of the data communication between the data processing stage and the selected other data processing stages in response to dynamically assigned communication relationships between data processing stage and the respective selected other data processing stages. This has the advantage that the synchronization relationships between the various data processing stages do not have to be specified at the design stage of the IC.

The dynamically assigned communication relationships are typically selected from a group of relationships including an asynchronous communication relationship, a producer-controlled producer to consumer (P2C) communication relationship and a consumer-controlled producer to consumer (C2P) communication relationship.

Preferably, the data processing stages each comprise an input buffer for storing incoming data from a communication path and an output buffer for storing outgoing data to a further communication path, the software layer being arranged to refresh data stored in the input buffer when the hardware layer is in an idle state and to output data stored in the output buffer in response to a task completion signal from the hardware layer. The software layer controlled buffers ensure that data is only updated or released when the hardware layer does not access this data, thus preventing data corruption.

Advantageously, each software layer is arranged to switch its data processing stage to a power-down mode during an inactive period of the data processing stage, i.e. as soon as the data processing stage has finished its processing. Because the software layers communicate synchronization status information with each other, this information can be propagated to wake-up upstream or downstream data processing stages. For instance, a data processing stage that is a producer in a C2P synchronization relation with a consumer data processing stage can be switched to a power-down state until the consumer signals the ability to receive a data packet.

It is also advantageous if each software layer is further arranged to send an activation signal to an associated software layer when powering down its data processing stage. For instance, when a consumer in a C2P synchronization relation is powered down because it has completed its processing task, an associated producer will be activated by the activation signal.

According to a further aspect of the present invention, there is provided a data processing stage for use in an integrated circuit as claimed in claim 1-7, the data processing stage comprising a hardware layer for processing data received through a data communication path; a software layer arranged to communicate with the software layers of selected other data processing stages to control the synchronization of the data communication between the data processing stage and the selected other data processing stages in response to dynamically assigned communication relationships between data processing stage and the respective selected other data processing stages. Such a data processing stage, which may be an IP block or a separate IC, can be readily integrated in an IC of the present invention without having to fix the communication relationship between the data processing stage and another data processing stage during the design phase of the IC.

According to a yet further aspect of the present invention, there is electronic device comprising an integrated circuit as claimed in any of claims 1-7, wherein the electronic device comprises data capturing means coupled to an input of a first data processing stage of the integrated circuit and output means coupled to an output of a further data processing stage of the integrated circuit. This device benefits from the presence of the IC of the present invention because a wider variety of audio and/or video processing tasks can be mapped onto this IC.

The invention is described in more detail and by way of non-limiting examples with reference to the accompanying drawings, wherein:

It should be understood that the Figures are merely schematic and are not drawn to scale. It should also be understood that the same reference numerals are used throughout the Figures to indicate the same or similar parts.

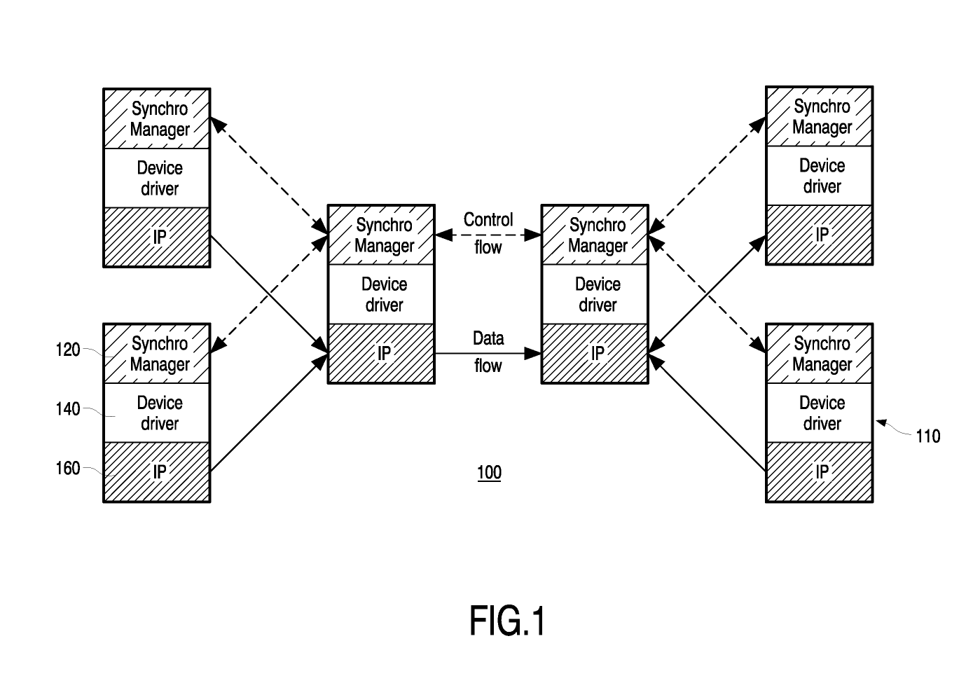

FIG. 1 shows an example of an IC 100 having a plurality of data processing stages 110. Each data processing stage 110 has a hardware layer 160 (IP) controlled by a device driver 140 and triggered by a software layer 120 (labelled Synchro Manager). It will be appreciated that the software layer 120, which may also be referred to as a software agent, may be a part of the data processing stage 110 in addition to other software layers or software agents.

The hardware layers 160 of the various data processing stages 110 communicate data packets with each other, with the transmission of data packets between the hardware layers 160 being controlled by the software layers 120. The software layers 120 are configurable, e.g. by configuration data provided by a processor (not shown) in response to a request from a user to execute a particular function implemented by the IC 100. Typically, the IC 100 is arranged to execute a number of different data processing functions that require different communication relationships in terms of synchronization between the data processing stages 110. The configuration information provided to the software layers 120 is used to dynamically set up these communication relationships. This has the advantage that such relationships may be added after the design of the IC 100 has been completed, thus adding flexibility to the data processing functionality of the IC 100.

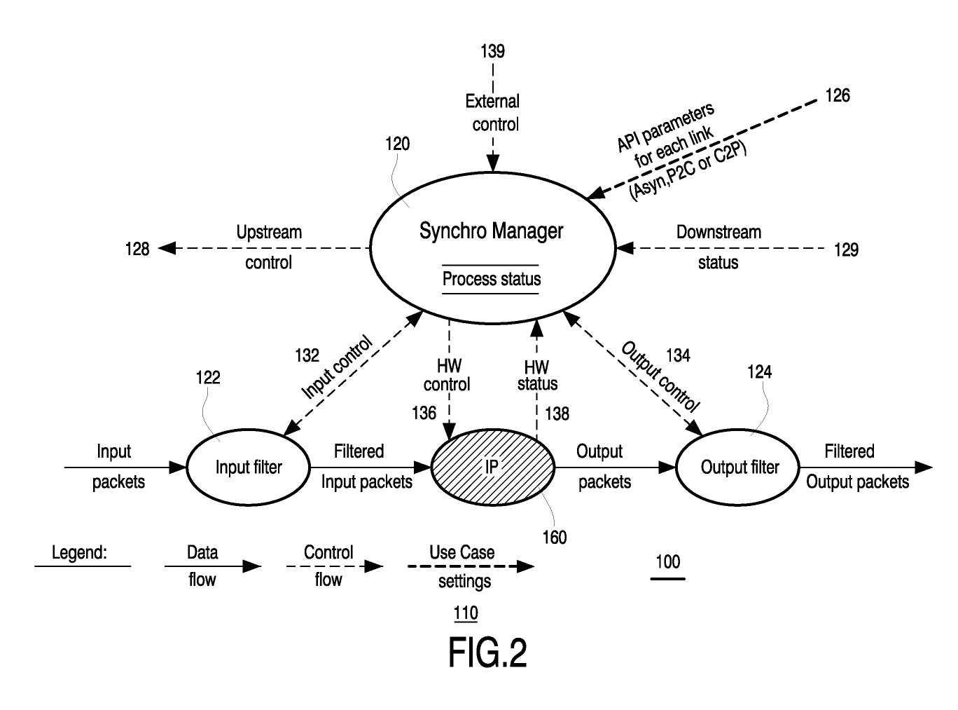

FIG. 2 provides a more detailed view of the functionality of a data communication synchronization managing software layer 120 a data processing stage 110. The software layer 120, which is typically running on a processor of a data processing stage 110, is arranged to control a data input filter 122 via control channel 132 and a data output filter 124 via control channel 134. The purpose of the data filters will be explained in more detail below.

The software layer 120 is further arranged to receive configuration information via channel 126. This configuration information specifies the synchronization relationship of the hardware layer 160 with the hardware layers 160 of other data processing stages 110 that are involved in the specific processing task to which the configuration information relates. The synchronization relations are typically chosen from a group of configuration relations including:
a) an asynchronous communication relation, in which the data processing stages 110 send data to each other over a communication channel in an independent fashion;
b) a consumer controlled producer to consumer relation, in which a data consuming data processing stage notifies a data producing data processing stage that it is ready to receive a data packet, which triggers the production of the data packet by the producing data processing stage; and
c) a producer controlled producer to consumer relation, in which a data producing data processing stage notifies a data consuming data processing stage that a data packet has become available, which triggers the processing of the available data packet by the consuming data processing stage.
   The notifications referred to in synchronization relations b) and c) are typically communicated between software layers 120 via the respective input synchronization control channels 128 and output synchronization control channels 129.

The software layer 120 is further arranged to receive status information from the hardware layer through hardware status channel 138 and to control the hardware layer 160 through hardware control channel 136. For instance, in case the hardware layer 160 is arranged to receive data from a hardware layer 160 of another data processing stage 110 according to a producer-controlled producer to consumer relationship, the consumer hardware layer 160 may be powered down until its associated software layer 120 receives the notification from the software layer 120 associated with the producing hardware layer that a data packet is ready to be consumed. This notification will trigger the software layer 120 of the consuming data processing stage 110 to send an activation signal to the hardware layer 160 via hardware control channel 136. It will be appreciated that a similar strategy can be applied to a data producing hardware layer in a consumer controlled synchronization relationship.

The hardware status information received by the software layer 120 via hardware status channel 138 can be used in several ways. For instance, the signalling of the completion of a task by the hardware layer 160 can be processed by the software layer 120, which subsequently can send a notification signal to a software layer 120 of an associated hardware layer 160, i.e. of another data processing stage 110 to signal the completion of the task processed by its hardware layer 160, i.e. signalling the availability of a data packet.

The data filters 122 and 124 are controlled by the software layer 120 to ensure that the receiving hardware layer receives the correct version of the data. For instance, if a hardware layer 160 is switched to an idle state under control of a downstream consumer, the input data filter 122 may still receive data from an upstream producer, for instance when the upstream producer and the idle hardware layer communicate asynchronously with each other. The input data filter 122 ensures that any received data from the upstream producer replaces the data stored in the input data filter 122 as long as the hardware layer 160 remains idle. This ensures that the hardware layer 160 will have access to the freshest version of the data when switched to an active state.

Similarly, if the hardware layer 160 is active, any data received by the input data filter 122 is discarded to ensure that the data currently operated on by the hardware layer 160 is not overwritten during its processing. In case an external multi buffer arrangement is used between two data processing stages 110, the input data buffer 122 may be updated according to the external buffer implementation strategy, e.g. a first-in-first-out or first-in-last-out strategy. New data might be added to the external multi buffer in accordance with its size and implementation.

The output data filter 124 has a similar purpose; for instance, the data produced by the hardware layer 160 may overwrite older versions of data stored in the output data filter 124. Only when hardware layer 160 has finished its current processing task, will the output data filter 124 allow any existing downstream data access mechanism to access the output data. It will be appreciated that the data filters 122 and 124 are used to implement data freshness principles, and other data filtering scenarios in which data freshness has to be achieved are equally applicable. In short, the filters 122 and 124 provide consistency to data flow so that input data are processed by the data processing stage 110 during a slice of time controlled by the synchronization manager, i.e. software layer 120, and all output data produced by the data processing stage 110 are forwarded to the downstream component during a slice of time controlled by the synchronization manager.

The synchronization manager 120 is arranged to handle the following control flows:

Input Control:

$${\sum }_{i} {IN}_{i , n}$$

identifies input data flow coming from upstream IPs, or data processing stages. The data processing stages 110 are sequentially numbered for reference purposes. The first index (i) stands for the upstream data processing stage number. The second index identifies the n^{th} data element in a stream of data elements. For instance, the data processing stage with i=3 sequentially sends n+1 data samples: IN_{3,0}, IN_{3,1}, IN_{3,2} . . . IN_{3,n}

IN*ₙ identifies the input data flow coming from the only one data processing stage 110 used as synchronization master (if any). The synchronization master is the data processing stage that drives the synchronization of the data transfer between the data processing stages 110 of the IC 100. For example: an upstream synchronization master IP sends sequentially n+1 samples: IN*₀, IN*₁, IN*₂ . . . IN*ₙ

Hardware Layer Status

An IRQ signal received by the synchronization manager 120 through hardware status channel 138 indicates that the hardware layer 160 has finished processing the current data stream element, e.g. the current data packet. This is common status information that can be readily provided by any kind of hardware layer 160. If this status information cannot be provided, then the relevant data processing stage 110 cannot be a synchronization master and will only support asynchronous or slave behaviour. This is because a synchronization master has to send control information to other synchronization managers 120, which typically is generated in response to the hardware status information. The hardware layer status may be written in a storage location of the synchronization manager 120. The possible status values are labelled Pₒₙ and P_{off}.

Upstream Status:

A status signal Cdone informs an upstream data processing stage 110, i.e. a producer, that its associated consumer has completed data processing its current data stream element and is now idle. Such information is typically provided over the control channels 128 and 129. It will be appreciated that the downstream control channel 129 of an upstream synchronization manager is physically the same channel as the upstream control channel 128 of the associated downstream synchronization manager. It will also be understood that this status signal is required for consumer controlled producer to consumer synchronization behaviour, where a producer needs to know when to produce the next data packet, and its generation is triggered by the consumer hardware layer 160 generated IRQ signal.

Downstream Status:

A downstream synchronization manager may provide a status signal Cdone to indicate that the downstream data processing stage 110 (customer) has finished its job and is now idle. This status signal is required for consumer controlled producer to consumer synchronization behaviour, and is triggered by generation of the IRQ signal in a downstream hardware layer 160.

Single Synchronization Source:

When synchronized, any data processing stage 110 can have no more than a single master. The three cases are:

a) The data processing stage 110 has no master, in which case its inputs are

$${\sum }_{i} {IN}_{i , n}$$

and its outputs are

$${\sum }_{i} {OUT}_{i , n}$$

b) The data processing stage 110 has an upstream master (P2C synchronization), in which case its inputs are

$${\sum }_{i} {IN}_{i , n} + {IN}_{n}^{*}$$

and its outputs are

$${\sum }_{i} {OUT}_{i , n} ,$$

with IN*ₙ being used to trigger the IP.

c) The data processing stage 110 has a downstream master (C2P synchronization), in which case its inputs are

$${\sum }_{i} {IN}_{i , n}$$

and its outputs are

$${\sum }_{i} {OUT}_{i , n} + {OUT}_{n}^{*} ,$$

in which OUT*ₙ released by a downstream synchronization master can be used to activate an upstream data processing stage. In situations where OUT*ₙ only identifies the data flow between the upstream data processing stage and its downstream master, then the Cdone signal is preferably used for triggering purposes.

External Control:

The software layer 120 is further responsive to signals provided via further control signal 139, through which a reset or a start signal may be provided. The reset signal resets the whole synchronization mechanism and the start signal triggers the initialization of the data processing stage 110. This start signal can be used as a generic start-up control command.

Each synchronization manager is arranged to provide the following outgoing control flows:

Output Control:

$${\sum }_{i} {OUT}_{i , n}$$

identifies output data flow outgoing to downstream data processing stages 110 that are not synchronized. The first index stands for the upstream data processing stage number, and the second index is the sequential index; for instance a data processing stage that has been assigned a sequential number 3 sequentially receives n+1 samples: OUT_{3,0}, OUT_{3,1}, OUT_{3,2} . . . OUT_{3,n}.

OUT*ₙ identifies the output data flow provided to the data processing stage 110 that has been chosen as the synchronization master. E.g. a downstream master sequentially receives n+1 samples: OUT*₀, OUT*₁, OUT*₂ . . . OUT*ₙ. It will be obvious that if such a master is connected upstream, then no OUT*ₙ packets are sent downstream.

Hardware Control:

As previously explained, a synchronization manager may be arranged to control the status of the hardware layer 160 of its associated data processing stage 110. A signal Pₒₙ may be generated to activate the hardware layer 160, whereas a signal P_{off} may be generated to switch the hardware layer 160 to a low-power state. Such signals may be provided via hardware control channel 136.

The software layer 120 may use the following synchronization algorithms to implement the functionality of the synchronization manager. The algorithms can be classified in four categories. A generic category, which is common to every synchronization type, and three synchronization type specific categories, i.e. C2P, P2C or asynchronous data communication behaviour specific. The synchronization algorithms are defined with the following injective function:

S(InputEvents)={OutputEvents}

in which InputEvents represents one or several incoming events, and OutputEvents represents one or several outgoing events.

3.1—Common Algorithms

Reset

| | |
|---|---|
| Goal | Used to reset the synchronization algorithm. |
| Equation | $S ( reset ) = {\sum }_{i} {IN}_{i , 0} + {IN}_{0}^{*} + {\sum }_{i} {OUT}_{i , 0} + {P}_{off , 0}$ |
| Description | Data flow numbering is set back to zero. The data |
| | processing stage 110 is reset and put into an idle state. |

Freshness for idle data processing stage

| | |
|---|---|
| Goal | When a data processing stage 110 is idle, its input data flows shall |
| | be refreshed. |
| Equa- tion | $S ( {IN}_{k , m > {n}_{k}} , {P}_{off , n} ) = {\sum }_{i \neq k} {IN}_{i , {n}_{i}} + {IN}_{k , m} + ⌊ {IN}_{n}^{*} ⌋ + {\sum }_{i} {OUT}_{i , {n}_{i}} + {P}_{off , n}$ |
| De- | When the data processing stage (IP) 110 is idle for the n^{th} time |
| scrip- | (P_{off,n}) and IPₖ (which is not the synchronization master), send new |
| tion | data IP_{k,m} (so that m > nₖ), then: |
| | IP state stays idle (P_{off,n}), and the previous data (IN_{k,n}) send by IPₖ |
| | is replaced by the new one (IN_{k,m}). |
| | Subsequently, (IN_{k,n}) is given back to any upstream sender. |
| | Note: the n^{th} data send by IPₖ may not have the same numbering as |
| | the data streams coming from other IPs. In such a case, a sub- |
| | numbering according to the IP index (k) may be used (nₖ). |
| | All other data flow (i.e. index i ≠ k) is kept unchanged for both |
| | input and output: |
| | ${\sum }_{i \neq k} {IN}_{i , {n}_{i}} + {\sum }_{i} {OUT}_{i , {n}_{i}}$ |
| | This includes INₙ* if existing and in use. |

No freshness for active data processing stage

| | |
|---|---|
| Goal | When IP is active, input data flows shall be not be refreshed |
| | (implemented by input data filter 122). |
| Equation | $S ( {IN}_{k , m > {n}_{k}} , {P}_{on , n} ) = {\sum }_{i \neq k} {IN}_{i , {n}_{i}} + {IN}_{n}^{*} + {P}_{on , n}$ |
| Description | When a data processing stage 110 is active for the n^{th} time |
| | (P_{on,n}) and IPₖ (which is not the synchronization master), |
| | sends new data IP_{k,m} (so that m > nₖ), then: |
| | The data processing stage 110 state stays active (P_{on,n}), the |
| | previous data (IN_{k,n}) send by IPₖ is not replaced by the new |
| | one (IP_{k,m}), and all other data flow (for which index i ≠ k) |
| | is kept unchanged for input: |
| | ${\sum }_{i \neq k} {IN}_{i , {n}_{i}}$ |
| | The output data flow of the data processing stage 110 is |
| | kept invalidated as long as the processing stage has not |
| | finished processing the data. |
| | INₙ* when existing and in use should be kept unchanged. |

Source

| | |
|---|---|
| Goal | Initialize a data processing stage 110 as a data |
| | source |
| Equation | {INᵢ} = φ |
| Description | Source has no input data stream from another IP |

Sink

| | |
|---|---|
| Goal | Initialize a data processing stage 110 as a data sink |
| Equation | {OUTᵢ} = φ |
| Description | Sink has no output data stream to another IP |

Connection initialization algorithms

| | |
|---|---|
| Goal | Create an asynchronous link between data |
| | processing stages 110 |
| Equation | IN_{i,n}_{ᵢ} = OUT_{k,n}_{ₖ} |
| Description | Asynchronously bind the output port of IPₖ with the |
| | input port of IPᵢ. |
| | A sub-indexing my be used if the IPs 110 have |
| | several input and/or output ports |
| Goal | Create a P2C link between data processing stages |
| | 110 |
| Equation | IN_{i,n}_{ᵢ}* = OUT_{k,n}_{ₖ} |
| Description | Bind an IPₖ output port to an IPᵢ input port so that |
| | the upstream IPₖ (producer) will trigger downstream IPᵢ |
| | (consumer) |
| Goal | Create a C2P link between data processing stages |
| | 110 |
| Equation | IN_{i,n}_{ᵢ} = OUT_{k,n}_{ₖ}* |
| Description | Bind an IPₖ output port to an IPᵢ input port so that |
| | the downstream IPᵢ (consumer) will trigger the upstream |
| | IPₖ(producer) |

Hardware layer 160 signals completion of task

| | |
|---|---|
| Goal | The hardware layer 160 indicates the completion of its task so |
| | that the outputs of the data processing stage 110 are ready to |
| | be used (implemented by output data filter 124). |
| Equation | $S ( IRQ ) = {\sum }_{i} {IN}_{i , {n}_{i}} + {IN}_{n > 0}^{*} + {\sum }_{i} {OUT}_{i , n > 0} + {P}_{off , n + 1} + Cdone$ |
| Descrip- | The input data filters 122 do not change their contents because |
| tion | part of it may be reused: |
| | ${\sum }_{i} {IN}_{i , {n}_{i}} + {IN}_{n > 0}^{*}$ |
| | The output of the data processing stage 110 is validated by the |
| | output filter 124 so that the output data can be down streamed: |
| | ${\sum }_{i} {OUT}_{i , n > 0}$ |
| | The data processing stage 110 (or the hardware layer 160) |
| | may be switched from an active state to a passive state (this |
| | may be implicitly done by hardware itself): |
| | P_{off,n+1} |
| | Propagate a C2P triggering command if required: |
| | Cdone |

### P2C Synchronization Specific Algorithm

When a client application, i.e. a user-selected functionality, requires a P2C synchronization link between two data processing stages 110, the synchronization algorithm should implement the following control structure:

Producer part:

N/A

Consumer part:

| | |
|---|---|
| Goal | The upstream synchronization master triggers the consumer |
| | data processing stage 110 |
| Equation | $S ( {IN}_{m > n}^{*} ) = {\sum }_{i} {IN}_{i , {n}_{i}} + {IN}_{n + 1}^{*} + {P}_{on , n}$ |
| Description | Only new data coming from the upstream synchronization |
| | master triggers the next data processing task in the |
| | consumer. |
| | A) the consumer is in an idle state: |
| | The consumer goes in active state (P_{on,n}) when the new data |
| | is received. |
| | New data (n + 1) from the synchronization master is |
| | validated by the consumer input data filter 122: (INₙ₊₁*) |
| | The previous data (INₙ*) from the input data filter 122 is |
| | released to the upstream synchronization master IP. |
| | All other input data is kept unchanged: |
| | ${\sum }_{i} {IN}_{i , {n}_{i}}$ |
| | B) The consumer is in an active state: |
| | The consumer stays in the active state (P_{on,n}) and is not |
| | reset because its current processing should not be |
| | interrupted to prevent the loss of data. |
| | New data (m > n + 1) received from the synchronization |
| | master IP is blocked by the consumer input data filter 122 |
| | so that the consumer can keep on processing its current |
| | data: (INₙ₊₁*) |
| | All other input data flow are kept unchanged: |
| | ${\sum }_{i} {IN}_{i , {n}_{i}}$ |

### C2P Synchronization Specific Algorithm

When a client application requests a C2P synchronisation link between two data processing stages 110, the synchronization algorithm should implement the following control structure:

Consumer part:

N/A

Producer part:

| | |
|---|---|
| Goal | Downstream (consumer) synchronization master triggers the |
| | producer IP. |
| Equation | $S ( Cdone ) = {\sum }_{i} {IN}_{i , {n}_{i}} + {P}_{on , n}$ |
| Description | Receiving the Cdone control command from the |
| | downstream consumer IP, the producer IP shall be activated |
| | and use the input data currently available in its input data |
| | filter 122. |
| | If the producer IP is already active (e.g. it has not yet |
| | finished its previous processing task), the current task shall |
| | not be interrupted. |
| | Optional behaviour: |
| | Since both data processing stages 110 (i.e. producer and |
| | consumer) are supposed to have a similar data processing |
| | period, i.e. a period in the same order of magnitude, the |
| | producer IP is supposed to be idle when it receives a |
| | (Cdone) event. This implies that the data packet (OUTₙ₊₁*) |
| | has already been sent to the consumer IP. Consequently, the |
| | consumer IP releases (OUTₙ*) and sends (Cdone) at the |
| | same time. This means that the producer IP may use the |
| | reception of the released (OUTₙ*) as a triggering event |
| | instead of (Cdone). |
| | $S ( {OUT}_{n - 1 \_ released}^{*} ) = {\sum }_{i} {IN}_{i , {n}_{i}} + {P}_{on , n}$ |

Asynchronous Algorithm:

When a client application requests an asynchronous synchronization link between two data processing stages 110, the synchronization algorithm should add the following for both sides of the synchronization link:

| | |
|---|---|
| Goal | Triggering the IP (data processing stage 110) |
| Equation | $S ( Start , {P}_{off , n} ) = {\sum }_{i} {IN}_{i , {n}_{i}} + {P}_{on , n}$ |
| Description | The IP is triggered by an arbitrary (Start) event. This may |
| | be any internal event when the IP is clock independent of |
| | the other IP. Alternatively, it may be any arbitrary |
| | combination of external events such as (INₙ) sent or |
| | (OUTₙ₊₁) released by other IPs, and it may be any other |
| | kind of external event not described here. |

It will be appreciated that not all control signals that trigger a data processing action by a data processing stage 110 have to be generated inside the IC 100. For instance, an electronic device incorporating the IC 100 may have a data capturing device, e.g. a camera, a microphone, an antenna, and so on, which produces data packets that are forwarded to a data processing stage 110 of the IC 100. The data packets generated by the data capturing device may serve as a control signal for the receiving data processing stage 110 of the IC 100. Alternatively, the data capturing device may generate a control signal prior to the generation of the data packets to indicate the start of a data stream, which may be interpreted by the software manager 120 of the receiving data processing stage 110 as an initialization signal. The same principle applies if the electronic device has a data output device such as a display, a speaker, an antenna and so on. Obviously, the data capturing device and the data output device may also be an integral part of the IC 100.

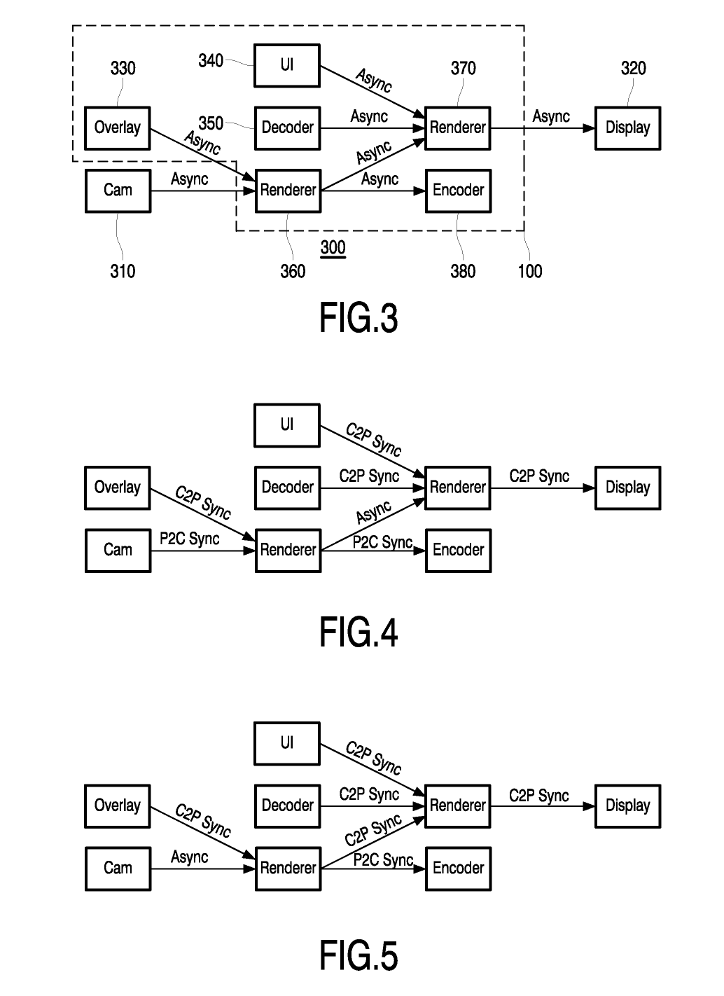

FIG. 3 shows a non-limiting example of an electronic device 300 that has a camera 310 and a display 320 coupled to an IC 100. As previously explained, other data capturing devices instead of or in addition to camera 310, and other data output devices instead of, or in addition to, display 320 are equally feasible. The IC 100 has a number of data processing stages, e.g. an overlay stage 330, a user interface 340, a decoding stage 350, rendering stages 360 and 370 and an encoding stage 380. Again, these stages are present by way of mere example only, and none of these stages are required to be present in any IC 100 according to the present invention.

FIG. 3 shows an electronic device 300 in which the various data processing stages have been configured to communicate with their associated neighbouring data processing stages in an asynchronous manner. This may for instance be an implementation of a use case (i.e. a user selected function) in which the camera 310 captures a video stream that is mixed with an overlay from overlay stage 320 by rendering stage 360. The resulting data stream is split into two streams; one stream that is encoded by encoding stage 380 and sent to e.g. a baseband processing stage (not shown) and another stream that is mixed with a man machine interface (MMI), e.g. data from user interface 340, by rendering stage 370 before being displayed on display 320.

However, due to the presence of the configurable synchronization managers (software layers 120) in the various processing stages of the IC 100, the electronic device 300 is not limited to the implementation of this particular use case. FIG. 4 shows the implementation of another use case on the electronic device 300. In this scenario, the camera 310 and display 320 operate at independent clock frequencies. This allows them to be used as separate synchronization masters, because their operation is not interrelated in terms of clock control. In FIG. 4, the camera 310 communicates with the rendering stage 360 according to a P2C synchronization protocol, with the overlay stage 330 communicating with the rendering stage 360 according to a C2P synchronization protocol, which is effectively controlled by the synchronization master, i.e. the camera 310. The rendering stage 360 further controls the encoding stage 380 in response to control signals from its synchronization master, i.e. camera 310. The other rendering stage 370 communicates with the display 320 according to a C2P synchronization protocol, i.e. is controlled by the display 320. The rendering stage 370 subsequently controls the user interface stage 340, and decoding stage 350 in response to the control signals received from its synchronization master, i.e. display 320.

FIG. 5 shows a use case in which the display 320 drives the whole system, i.e. acts as synchronization master for the whole system apart from the camera 310 because of the clock independencies between the camera 310 and the display 320.

The use cases displayed in FIGS. 3-5 are mere examples of the communication flexibility that is achieved using the configurable synchronization managers 120 on the data processing stages 110. It will be obvious that many other use cases can be implemented in the same way, i.e. by providing the respective synchronization managers 120 with the appropriate configuration data at the start-up of the corresponding use case.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements. In the device claim enumerating several means, several of these means can be embodied by one and the same item of hardware. The mere fact that certain measures are recited in mutually different dependent claims does not indicate that a combination of these measures cannot be used to an advantage.

1. An integrated circuit comprising:
a plurality of data processing stages and;
a data communication network having a plurality of data communication paths between the data processing stages, each said data processing stage including
a hardware layer for processing data received through one of said data communication paths; and
a software layer arranged to communicate with the software layers of selected other said data processing stages for controlling synchronization of data communication between the data processing stage and the selected other said data processing stages in response to dynamically assigned communication relationships between the data processing stage and the respective selected other said data processing stages.

2. An integrated circuit as in claim 1, wherein the dynamically assigned communication relationships are selected from a group of relationships including an asynchronous communication relationship, a producer-controlled producer to consumer communication relationship and a consumer-controlled producer to consumer communication relationship.

3. An integrated circuit as in claim 1, wherein the data processing stages each comprise an input buffer for storing incoming data from a communication path and an output buffer for storing outgoing data to a further communication path, the software layer being arranged to refresh data stored in the input buffer when the hardware layer is in an idle state and to output data stored in the output buffer in response to a task completion signal from the hardware layer.

4. An integrated circuit as in claim 1, wherein the software layer of one of the data processing stages is assigned to act as a data communication synchronization master of the data communication network, the assigned software layer being responsive to the hardware layer of its data processing stage.

5. An integrated circuit as in claim 1, wherein each said software layer is arranged to switch its data processing stage to a power-down mode during an inactive period of the data processing stage.

6. An integrated circuit as in claim 5, wherein each said software layer is further arranged to send an activation signal to an associated said software layer when powering down its data processing stage.

7. An integrated circuit as in claim 1, wherein the dynamic assignment of communication relationships is triggered by a user-selected function of the integrated circuit.

8. A data processing stage for use in an integrated circuit as in claim 7, the data processing stage comprising:
a hardware layer for processing data received through a data communication path;
a software layer arranged to communicate with the software layers of selected other data processing stages to control synchronization of data communication between the data processing stage and the selected other said data processing stages in response to dynamically assigned communication relationships between the data processing stage and the respective selected other said data processing stages.

9. An electronic device comprising an integrated circuit as in claim 1, wherein the electronic device comprises a data capturing element coupled to an input of a first data processing stage of the integrated circuit and an output element coupled to an output of a further data processing stage of the integrated circuit.
